(19) United States
(12) Patent Application Publication
(10) Pub. No.: US 2009/0010010 A1
(43) Pub. Date: Jan. 8, 2009

(54) LED DIRECT-PLUGGING TYPE MULTI-CHIP HIGH POWER LIGHT SOURCE

(76) Inventors: Baoyan CHANG, Shenzhen (CN); Xianghong Yang, Honghu City (CN); Zheng Xu, Honghu City (CN)

Correspondence Address: LOWE HAUPTMAN HAM & BERNER, LLP, 1700 DIAGONAL ROAD, SUITE 300, ALEXANDRIA, VA, 22314, US

(21) Appl. No.: 12/043,409

(22) Filed: Mar. 6, 2008

(30) Foreign Application Priority Data
Jul. 2, 2007 (CN) 200720121161.1

(51) Int. Cl. F21V 29/00

(52) U.S. Cl. 362/373

(57) ABSTRACT

The present invention provides a LED direct-plugging type multi-chip high power light source, comprising a heat dissipating substrate, a protecting rubber ring mounted at the obverse of the heat dissipating substrate, LEDs fixed on the heat dissipating substrate and in the protecting rubber ring, the heat dissipating substrate being provided with two through holes impenetrating its obverse and inverse, in each of the two through holes separately provided with a pin connecting to the LEDs, one end of the pin inserted into the through hole and the other end of the pin led out from the inverse of the heat dissipating substrate to the outside of the heat dissipating substrate, and the part of the pins inserted in the through holes being separated from the heat dissipating substrate by a dielectric. The heat dissipating substrate is made of high heat conduction metal. In the present invention, the heat dissipating substrate is made of high heat conduction metal, and the heat conducting pole is abolished. Comparing with the conventional art, the present invention decreases the heat dissipating path, increases the sectional area, and eliminates the intermediate link of high thermal resistance. The present invention increases the power of a single light source, decreases the attenuation of light greatly, and increases the useful life greatly.

### RELATED APPLICATIONS

The present application is based on, and claims priority from, China Application Number 200720121161.1, filed Jul. 2, 2007, the disclosure of which is hereby incorporated by reference herein in its entirety.

### BACKGROUND OF THE INVENTION

1. Field of the Invention

The present invention relates to an illuminating device, particularly relates to a high power LED light source.

2. Description of the Related Art

As a new type of light source, LED gradually concerns all the countries in the world. Comparing with the traditional light source, LED involves the advantages: 1, having better safety, belonging to cold light source device, being driven in low voltage, having firm structure, not falling to pieces; having long useful life, lasting 50-100 thousand hours in a good heat dissipation condition, which is much longer than other light sources; 2, having rich colors, being regulated and controlled easily; 3, improving luminous efficiency greatly year after year, the general products achieving 60-80 lm/w now, which is much better than incandescent lamps of 15 lm/w, equaling 80 lm/w of fluorescent lamp with best luminous efficiency, and to exceed the luminous efficiency of other light sources is just a matter of time; 4, protecting the environment, having no heavy metal pollutions in waste materials, according with the standard of EU ROSH.

As a semiconductor device, LED has the inherent disadvantage of not enduring heat. Especially for the high power device, if failed to conduct and emit the heat generated in working, the temperature of the PN junction will rise leading to the great dropping in luminous efficiency; if the temperature of the PN junction is over 120° C., with time passing by unrecoverable attenuation of light or even dying of the lamp will occur, and it is very common that after 1000 hours the brightness will decrease over 50%. A familiar LED light source structure, as illustrated in FIG. 1, comprises a chip bonding plane 01, a heat conducting pole 02, a heat dissipating substrate 03, and a user radiator 04. The structure comprises disadvantages that sectional area of the heat conducting pole 02 is small, the heat conducting path is long, and the thermal resistance is great. Commonly, silicone 05 is used to connect between the heat conducting pole 02 and the heat dissipating substrate 03, even if tin-lead solders were used, that will become a big thermal resistance region. For the thermal resistance is great, the structure can only conduct limited heat. So with the structure, only 1-3 W light source can be produced, and the light source of above 5 W will have short useful life due to absence of conducting heat.

### SUMMARY OF THE INVENTION

The present invention provides a LED direct-plugging type multi-chip high power light source with good heat dissipating capability, to solve the technical problem that the conventional LED lamps have bad heat dissipating capability and can not afford the high power LED to dissipate heat.

To solve above said problem, the technical solution of the present invention is to construct a LED direct-plugging type multi-chip high power light source, comprising a heat dissipating substrate, a protecting rubber ring mounted at the obverse of the heat dissipating substrate, LEDs fixed on the heat dissipating substrate and in the protecting rubber ring, the heat dissipating substrate being provided with two through holes impenetrating its obverse and inverse, in each of the two through holes separately provided with a pin connecting to the LEDs, one end of the pin inserted into the through hole and the other end of the pin led out from the inverse of the heat dissipating substrate to the outside of the heat dissipating substrate, and the part of the pins inserted in the through holes being separated from the heat dissipating substrate by a dielectric.

Wherein on the said heat dissipating substrate, a number of LEDs are arranged in a straight line type broken line, are divided into a number of groups; the LEDs of each group are connected to each other in series, and are connected to the pins via conductors.

The said protecting rubber ring has a circular hoop shape, and an electroplated coating is set at the internal wall surface of the protecting rubber ring.

The said dielectric is a glass dielectric ring formed by sintering of glass to fill between the pins and the heat dissipating substrate.

The said heat dissipating substrate is made of high heat conduction metal.

The said pins has a straight bar shape.

In the present invention, the heat dissipating substrate is made of high heat conduction metal, and the heat conducting pole is abolished. Comparing with the conventional art, the present invention decreases the heat dissipating path, increases the sectional area, and eliminates the intermediate link of high thermal resistance. The glass dielectric ring 5 formed by sintering of glass can fill the interspaces well, can withstand high voltage, have no leakage, and have high mechanical strength while separating the pins from the heat dissipating substrate to be insulated. The present invention increases the power of a single light source, decreases the attenuation of light greatly, increases the useful life greatly, and makes the LED being used in high power illuminating area.

Other objects, advantages and novel features of the present invention will be drawn from the following detailed embodiment of the present invention with attached drawings, in which:

### BRIEF DESCRIPTION OF THE DRAWINGS

FIG. 1 is a structure schematic diagram of a conventional LED lamp.

FIG. 2 is a front view of a preferred embodiment of the present invention.

FIG. 3 is a sectional view of FIG. 2 along the line A-A.

FIG. 4 is a structure schematic diagram of the protecting rubber ring in a preferred embodiment of the present invention.

FIG. 5 is a structure schematic diagram of a part of the heat dissipating substrate in a preferred embodiment of the present invention.

FIG. 6 is a stereogram schematic diagram of a preferred embodiment of the present invention.

FIG. 7 is a schematic diagram of the LED connection in a preferred embodiment of the present invention.

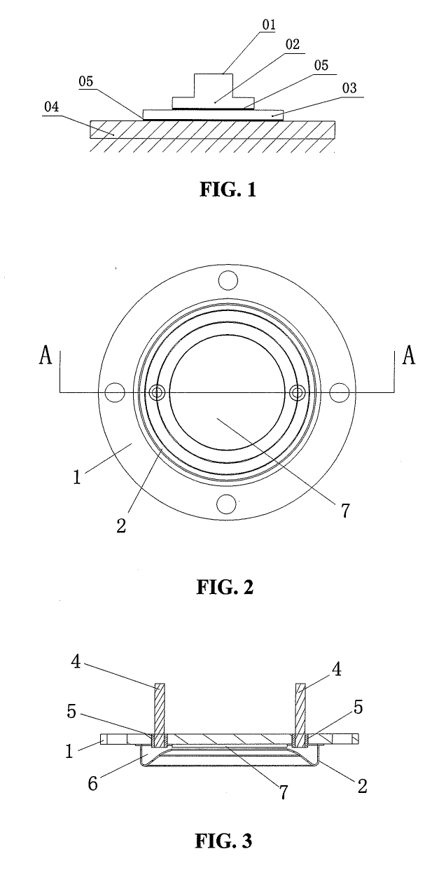

### DESCRIPTION OF THE PREFERRED EMBODIMENT

As illustrated in FIG. 2, FIG. 3, and FIG. 6, the basic structure of a preferred embodiment of the present invention is showed. The said LED direct-plugging type multi-chip high power light source comprises, a heat dissipating substrate 1, a protecting rubber ring 2 mounted at the obverse of the said heat dissipating substrate 1, LEDs 3 mounted on the heat dissipating substrate 1 and in the protecting rubber ring 2, the heat dissipating substrate 1 being provided with two through holes impenetrating its obverse and inverse, in each of the two through holes separately provided with a pin 4 connecting to the LEDs 3, one end of the pin 4 inserted into the through hole and the other end of the pin 4 led out from the inverse of the heat dissipating substrate 1 to outside of the heat dissipating substrate, the part of the pin 4 inserted in the through holes being separated from the heat dissipating substrate 1 by a dielectric 5.

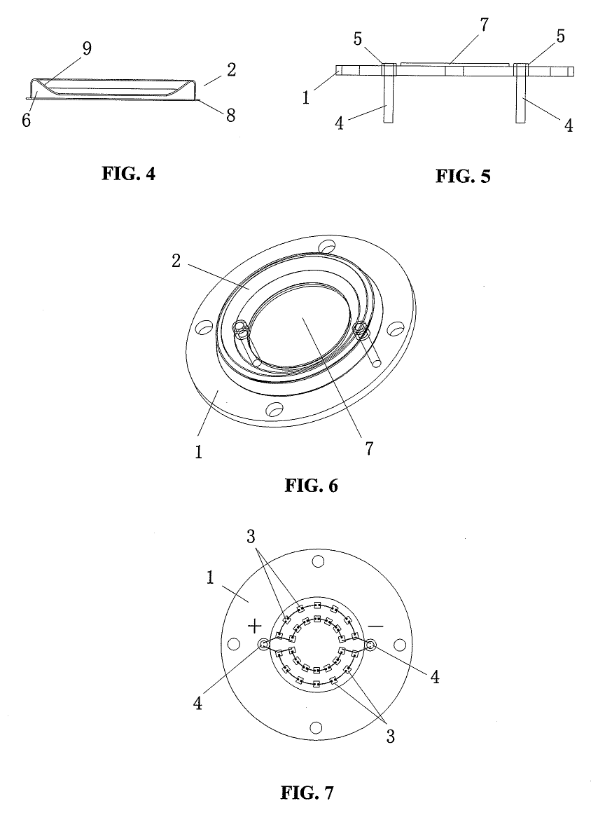

As illustrated in FIG. 5, in the present embodiment the heat dissipating substrate 1 is made of high heat conduction metal, which has a round shape. There is a raised truncated cone 7 set in the middle of the heat dissipating substrate 1. A number of LEDs 3 are set on the surface of the truncated cone 7, and are divided into a number of groups. The LEDs 3 of each group are connected to each other in series, and each group is separately connected to the two pins 4 via conductors (referring to FIG. 7). The pin 4 has a column straight bar shape. The said protecting rubber ring 2 has a circular hoop shape. An electroplated coating 9 is set at the internal wall surface of the protecting rubber ring 2, to enhance the light reflecting capability (as shown in FIG. 4).

In the present embodiment, the dielectric 5 is a glass dielectric ring 5 formed by sintering of glass to fill between the pins 4 and the heat dissipating substrate 1. The glass dielectric ring 5 formed by sintering of glass can fill the interspaces well, and have high mechanical strength while separating the pins 4 from the heat dissipating substrate 1 to be insulated.

In the present invention, the heat dissipating substrate is made of high heat conduction metal, and the heat conducting pole is abolished. Comparing with the conventional art, the present invention decreases the heat dissipating path, increases the sectional area, and eliminates the intermediate link of high thermal resistance. The present invention increases the power of a single light source (the present structure increases the power from conventional below 5 W to 10 W-30 W), decreases the attenuation of light greatly (below 5% for 1000 hours), increases the useful life greatly (more than 20000 hours), and makes the LED being used in high power illuminating area. The present invention can also be used with the user radiator together.

What is claimed is:

1. A LED direct-plugging type multi-chip high power light source comprising a heat dissipating substrate, a protecting rubber ring mounted at the obverse of the heat dissipating substrate, LEDs mounted on the said heat dissipating substrate and in the said protecting rubber ring, the said heat dissipating substrate being provided with two through holes impenetrating its obverse and inverse, in each of the said two through holes separately provided with a pin connecting to the LEDs, one end of the pin inserted into the through hole and the other end of the pin led out from the inverse of the said heat dissipating substrate to outside of the said heat dissipating substrate, the part of the said pin inserted in the said through holes being separated from the said heat dissipating substrate by a dielectric.

2. The LED direct-plugging type multi-chip high power light source of claim 1, wherein on the said heat dissipating substrate, a number of said LEDs are arranged in a straight line type broken line; the said LEDs are divided into a number of groups; the LEDs of each group are connected to each other in series, and are connected to the pins via conductors.

3. The LED direct-plugging type multi-chip high power light source of claim 2, wherein the said protecting rubber ring has a circular hoop shape, and an electroplated coating is set at the internal wall surface of the protecting rubber ring.

4. The LED direct-plugging type multi-chip high power light source of claim 3, wherein the dielectric is a glass dielectric ring formed by sintering of glass to fill between the pins and the heat dissipating substrate.

5. The LED direct-plugging type multi-chip high power light source of claim 4, wherein the said heat dissipating substrate is made of high heat conduction metal.

6. The LED direct-plugging type multi-chip high power light source of claim 5, wherein the said pins have a straight bar shape.
